(19) United States
(12) Patent Application Publication
(10) Pub. No.: US 2004/0085558 A1
(43) Pub. Date: May 6, 2004

(54) Page description language meta-data generation for complexity prediction

(75) Inventors: Wayne Minns, Rochester, NY (US); Thomas A. Henderson, Rochester, NY (US)

Correspondence Address: Lawrence P. Kessler, Patent Department, NexPress Solutions LLC, 1447 St. Paul Street, Rochester, NY, 14653-7103, US

(73) Assignee: NexPress Solutions LLC

(21) Appl. No.: 10/634,587

(22) Filed: Aug. 5, 2003

Related U.S. Application Data
(60) Provisional application No. 60/423,938, filed on Nov. 5, 2002.

(51) Int. Cl. G06F 15/00; G06F 3/12

(52) U.S. Cl. 358/1.11; 718/104; 718/102; 358/1.13

(57) ABSTRACT

A mechanism by which meta-data may be created and associated with a given page description language file. This meta-data could be considered as either a page description language complexity or raster image processor time estimate. The meta-data is derived via a complexity factor and (optionally) an accuracy factor. The meta-data may be utilized for raster processor page/surface ordering, preflight optimization, viewing optimization, or other embodiments.

### FIELD OF THE INVENTION

The present invention relates in general to printing instructions and more particularly to an improved control for Page Description Language (PDL) for print files.

### BACKGROUND OF THE INVENTION

As peripheral devices increase in sophistication, they provide numerous advantages to the user. However, with this increased sophistication comes an increase in processing complexity within the various peripheral devices. For example, as printers develop the ability to output high quality graphics, the processing time for different print files may vary dramatically. This can often cause a problem where a complex image consumes a large portion of the printer's availability. The printer may be unable to print more simplified files (text files) during a time when a more complicated image is being processed.

Therefore, there is a need to predict the complexity of jobs provided to peripheral devices to most efficiently utilize the capabilities of the peripheral device. Conventional problems addressed by this invention include the following. For multiple Raster Image Processor (RIP) systems there are problems associated with providing a page-rendering schema to efficiently and effectively utilize each of the RIPs in a productive fashion. Instead of utilizing a traditional page flow (1-N or N-1), a page order could be created that permits utilizing the available resources in a fashion that permits faster end to end processing or permits synchronizing RIP performance with downstream engine performance. For sales support, by providing an application utilizing the complexity prediction algorithm, customers or sales representatives could analyze typical customer workflows to determine their relative complexity. This complexity determination could assist in determining the appropriate level of configurations for the Digital Front End (DFE) or RIP for the customer to utilize (i.e., most cost effectively or most performance oriented). Soft proofing efficiency can be accomplished by providing a page ordering schema to efficiently and effectively utilize a soft proof application in a productive fashion. Instead of utilizing a traditional page flow (1-N or N-1), a page order could be created that permits utilizing the available resources in a fashion that permits faster end to end processing of pages or permits synchronizing with the viewing order the user is requesting (i.e., scrolling). As a ‘leveling’ device for a document or page spool system, traditional applications in a page spool are first in, first out. By utilizing a complexity predictor, the document or page spool could receive pages or could provide to requesting applications pages in an order that is appropriate for downstream processing applications which are affected by the complexity of the pages.

### SUMMARY OF THE INVENTION

In view of the foregoing description and other problems, disadvantages, and drawbacks of the conventional peripheral device, the present invention has been devised, and it is an object of the present invention to provide an improved control for PDL for print files.

In order to attain the object suggested above, there is provided, according to one aspect of the invention, a method of controlling printing devices. The invention first generates meta-data from printing instructions. Next, the invention examines one or more of the following: font attributes, font size, vector complexity, digital image content, digital image size, and digital image type to calculate a complexity prediction for each of the printing instructions. The invention estimates the processing time for each of the printing instructions based on the complexity prediction. The invention then evaluates the printing instructions based on the processing time.

The evaluating application produces either an order of processing of the printing instructions or a cost analysis of the printing instructions. The processing of the printing instructions includes one or more of raster image processing and spooling. The invention supplies an Accuracy Factor (AF) for the complexity prediction. The AF controls a processing precision of the complexity prediction calculation. The invention adds a Feedback Factor (FF) to the complexity prediction based on responses from downstream functions. The term printing can actually apply to printing, preflighting, or viewing. Processing may be for the purpose of generating derivative jobs, validating jobs, or actually imaging jobs.

### BRIEF DESCRIPTION OF THE DRAWINGS

The foregoing and other objects, aspects and advantages will be better understood from the following detailed description of a preferred embodiment(s) of the invention with reference to the drawings, in which:

FIG. 1 is a schematic diagram showing an architecture used by the invention to obtain the meta-data of print files;

FIG. 2 is a chart showing raster image processing time predictions for different print files;

FIG. 3 is a schematic diagram showing an example of the processing flow achieved with the invention;

FIG. 4 is a schematic diagram showing a print file being processed with the invention;

FIG. 5 is a flowchart showing the processing of the invention; and

FIG. 6 is a schematic diagram of a system implementing the invention.

### DETAILED DESCRIPTION OF THE INVENTION

The invention overcomes the shortcomings of conventional systems by adding derived information to a PDL that is based on content information in the PDL file. More specifically, the invention generates meta-data information and provides a complexity prediction for downstream functions. The invention uses the complexity prediction to schedule print processing of PDL files from a print server or a RIP manager. Scheduling could include document scheduling in the case of a multiple printer environment and/or it could include page or object scheduling in the case of a multiple RIP environment.

In one embodiment of the invention, an Adobe® Portable Document Format (PDF) PDL complexity prediction scheme is utilized to predict RIP page processing time. A PDF file contains instructions for creating marks on a page. A RIP accepts the PDF file and converts the instructions into values stored in a raster. When the raster is displayed on a computer screen, or printed to a piece of paper, an image of text, drawings or pictures is presented.

The conversion of PDF instructions into raster values often involves lengthy computer calculations. It is desirable to know in advance, the amount of time that will be consumed in creating a final raster image. The invention allows a RIP that processes many pages to know beforehand if some pages are likely to take longer than others. Additionally, by determining the Complexity Factor (CF), the invention provides estimates of the processing cost of a print job before actually committing computer resources. Estimating the RIP time takes only a small fraction of the time required to actually RIP the page.

PDF files are amenable to creating such an estimate. Unlike PostScript®, PDF files have a well defined finite sequence of processing steps. PDF files represent a list of operations. Since each imaging operation in a PDF is explicitly enumerated, the invention counts the operations and calculates the time they will take to estimate a final total processing time.

A PDF file can contain numerous pages, but each page is independently described. Therefore, the invention focuses on estimating the processing time for single pages, realizing that a PDF file is just a collection of such pages. Fundamental to such an operation is the concept of a resource. Each PDF file contains a list of resources that will be used to create the page. Resources can include fonts, graphic states, forms, sampled images and even fragments of PostScript® code.

In addition to resources, PDF defines a contents list for each page. The contents list specifies a matching between page elements and resources, along with specific instructions about the size and where the elements should be located within the raster. For example, a given page may indicate the Times Roman font and specify a location and size for each character. A contents stream contains all the instructions for constructing the image raster, given a resource list. To estimate the RIP time for a page, a special PDF interpreter counts the number of characters, and multiplies by a factor, which is predetermined for this size of Times Roman font. The invention can then tell, for example, that one page would take twice as long to rasterize as a page containing half as many characters, or composed with Arial fonts instead of Times Roman.

As demonstrated in this example, the PDF file format is amenable to RIP time prediction. A software program that acts much like a normal RIP, but foregoes the lengthy calculations associated with actually making an image raster, can provide an estimate of the time it will take to RIP a print page, or job.

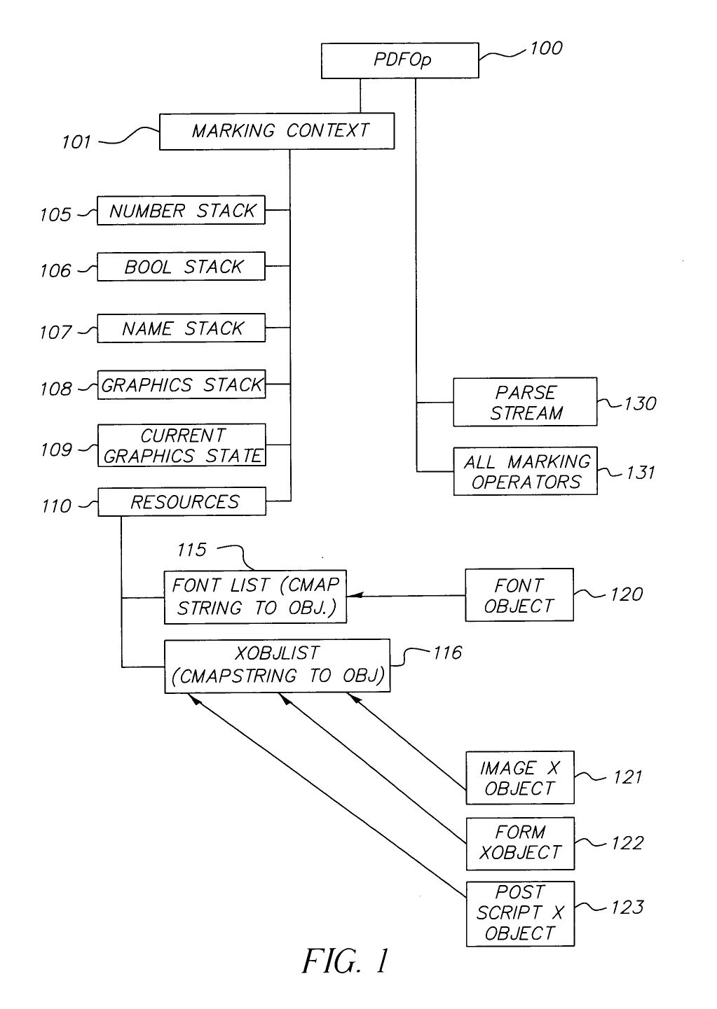

Referring now to FIG. 1, an architecture for calculations is shown. Each box represents a class, or function, in a programming language such as C++. The root class, PDFOp (operations) 100, is responsible for the overall program control. This class opens the PDF file and begins interpretation. Just as is normally done in a PostScript® or PDF interpreter, some stacks are maintained to store latent information in the context of a particular calculation. In this design, separate stacks are provided for numbers 105, boolean values 106, names 107, graphics 108, and current graphic state 109. In addition to graphic stack 108, there is a current graphic state 109, which holds such information as the coordinate transform matrix, clipping path, line thickness and a host of other parameters that help to define the marks that will be written into a raster.

As the contents stream describing a particular page is analyzed, various PDF commands that insert items onto the stack are encountered. These stack structures 105-109 are provided to receive them, just as would occur if the PDF file were being rasterized. The stacks 105-109 are elements of a construction called marking context 101. The marking context 101 provides the environment to correctly interpret PDF marking commands. The context can change through the action of other commands.

Also, part of the marking context 101 is a list of resources 110. A more formal name for this is resource dictionary, but for simplicity the term resources is used. The resources 110 object is constructed by examination of the resource dictionary in a PDF file. That data structure includes all fonts that will be used later in the contents stream. A font object 120 is constructed to reflect pertinent information about the font. The font object 120 can be referenced using Microsoft®'s CmapStringToObj template (FontList 115), for example. This is just one way to associate a name with some software object in a collection of similar objects. Likewise, other resources include imageXobjects 121, FormXobjects 122, and PostScript®Xobjects 123 within the XObjList 116.

Focusing first on fonts, there is a difference between the PDF RIP time estimator and a true RIP. In a real RIP, a font object would hold all the instructions necessary to actually draw the text character in the raster. With the inventive estimator, however, the font object stores only the level of complexity needed for that font. There is no need to actually draw the character and, in fact, the invention avoids this so that the estimate does not take as much time to complete as a real RIP would.

The data for a given font is acquired by measuring the RIP time of pages that contain all characters printed only in that font. In addition, a weight for that time depending on font size is included in the font object 120. To estimate the RIP time for a page containing only text, the estimator need only count the characters with a given font and font size, extract the RIP time information from the font object 120, and multiply. The number obtained in this way can then be summed with text in other fonts or sizes, and summed with other image elements on the page.

The right side of FIG. 1 shows routines that will parse the contents stream and form tokens from characters read from the PDF objects, generally referred to as ParseStream 130, when a marking operator is found, ParseStream 130 calls subroutines that execute to effect the action of those operators by calling a subroutine for each verb discovered in the PDF stream, generally referred to as all marking operators 131. Taken together, the subroutines 130, 131 eventually yield the estimate of RIP time, when the end of the contents stream is reached.

An application, as a component of the RIP or as a separate application in front of the RIP (i.e. in a preflight or workflow application or as a preprocessing component in the DFE), is created utilizing the invention herein to attach a CF value to each PDF page in the job. In a system having a single RIP with a workflow whereby there is a page stored post RIP and pre-engine in the system, the processing time between the page store and the engine must be guaranteed to be real time to assure data flow to the engine.

In this example, in a traditional system, with no optimization, the job will process as follows: RIP Time to load page buffer: approximately 22 minutes (67/3 minutes), print time to print from page buffer: 20 minutes (20 pages at 1 PPM), and total time from job receipt to job produced: 42 minutes. With the CF being utilized, pages could be ordered in such a way that the system could guarantee running from the page buffer to the engine prior to the whole job being rasterized. In the scenario below, the total system time would be as follows: RIP time to sufficient load page, buffer: approximately 11 minutes (35/3 minutes) print time to print from page buffer: 20 minutes (20 pages at 1 PPM) total time from job receipt to job produced: 31 minutes. Thus, the net savings utilizing this scenario is a print production time savings of 11 minutes.

Assume for simplicity the engine runs at 1 page per minute. Further assume that a CF of 3 equates to a RIP performance of 1 page per minute (i.e., a page with a CF of 3 will RIP in 1 minute OR 3 pages each with a CF of 1 will RIP in 1 minute as well). In this example, there is a 20 page document submitted for printing. The complexity predictor has added meta-data information to the PDF document.

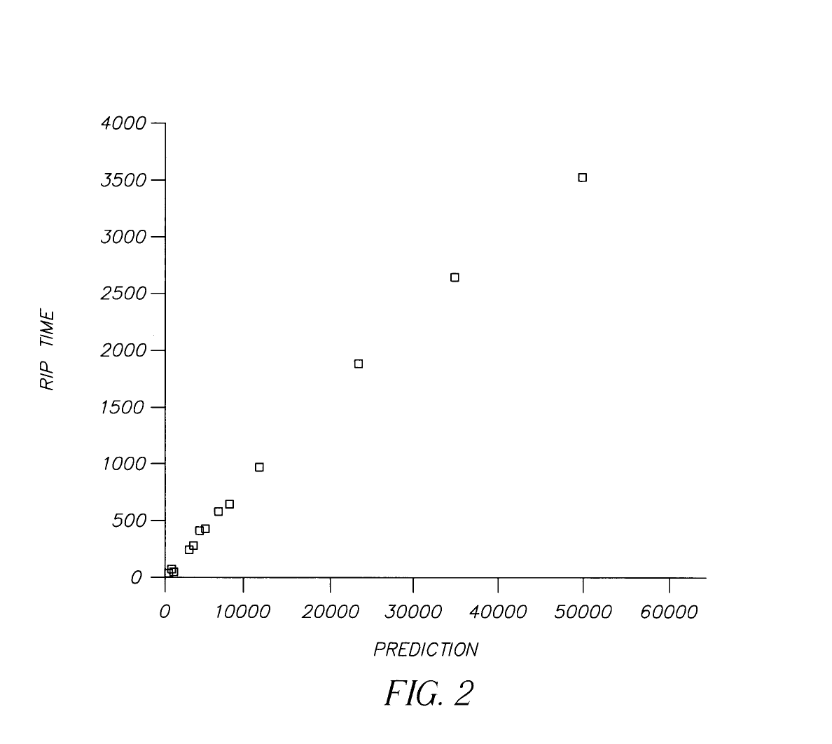

FIG. 2 shows a correlation between actual RIP time and a prediction based on the principles outlined above. In this example, pages containing varying amounts of text were measured for RIP time. The results of the predictor, in arbitrary units, appear on the x axis.

To be effective at estimating RIP time, the estimator must be able to account for all expected image elements, not just text. This can be a challenge because a PDF file will have self-contained marking contexts that can be executed at any time. A FormXobject 122 is such an example, where all the drawing actions of the form can be repeated on the page, conceivably at different orientation and magnifications. Likewise, an imageXobject 121 can be made large in one instance and small in another.

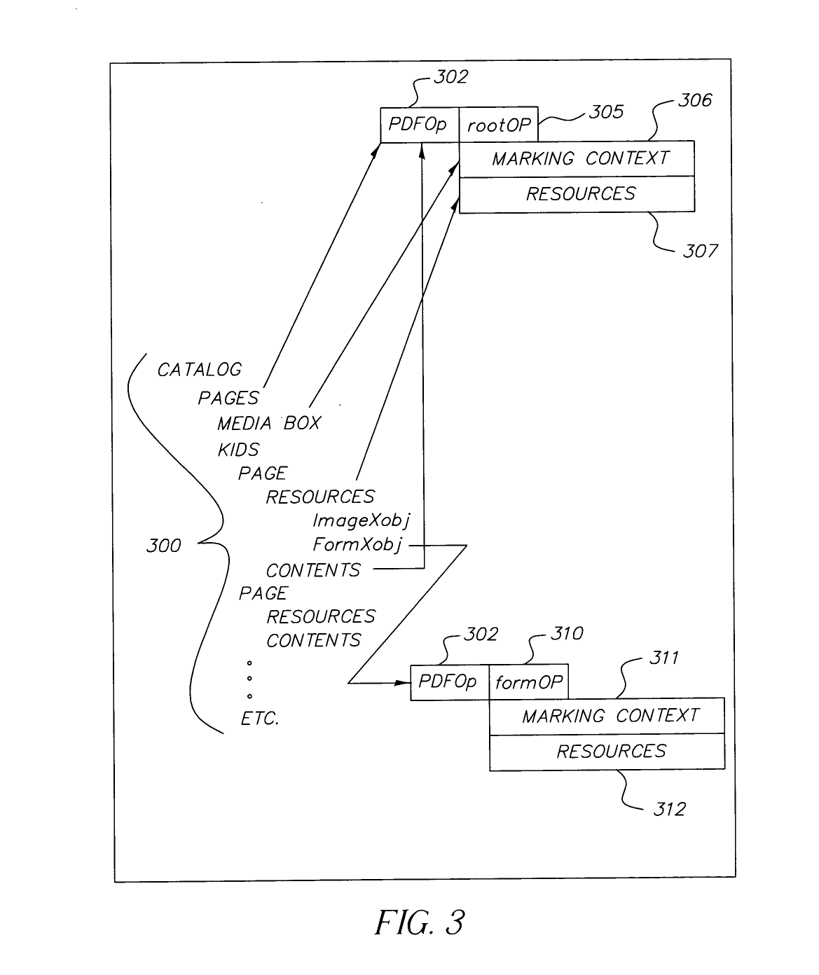

FIG. 3 shows a basic processing, which takes these recurrent image objects into account to increase the effectiveness of the RIP estimation. On the left side is shown the hierarchy of PDFobject 300, starting with the root of the document, the catalog. Once a page entry is found in the catalog, PDFOp 302, called rootOp 305 is created to encompass all operations that will occur on pages. The rootOp 305 has a marking context 306 and a list of resources 307. When the contents stream of a page is interpreted, reference is made to the marking context 306 and resources 307 of rootOp 305.

A formOp 310 is another instance of PDFOp 302 construct created by encountering a PDFobject 300. Just as in the case of rootOp 305, it includes marking context 311 and a list of resources 312. It describes a self contained set of operations that will ultimately estimate the RIP time of the form. When a PDFObject 300 of the type FormXobj is encountered in a content stream, its own PDFOp 302 is constructed, and an estimate of the time consumed to draw the form is computed and summed with other page elements.

In both cases, the function of the PDFOp 302 is to accumulate the RIP times for each individual page element. This operation for text is shown above. For images, two aspects must be considered. One is the size of the input image and another is the size of the output. A larger input image, that is, one containing more samples, will take more time to rasterize for various reasons. One reason is that a larger quantity of data simply takes longer to read from a source, like a disk. Then, if interpolation is enabled, the RIP must compute the sample averages, or interpolants, that will be placed into the raster memory. On the output side, the size matters simply because a larger output means writing more bytes to memory. The output size will depend on the marking context, which has been maintained by the PDFOp 302 process.

The representation of the imageXobj takes these variables into account, in order to compute a RIP time estimate, whenever a reference to an image object is discovered in a content stream. The inventive estimator saves time by ignoring the actual rendering of the imageXobj. This maintains an efficient calculation because the actual rendering is not needed in order to estimate the time consumed to render the image.

Two main categories of image content have been discussed, text and sampled images. What remains to be discussed is vector graphics. The RIP time for graphic elements is a function of the number of vector graphic operations. First, it is not necessary to know details about the size of the graphic elements. To include the contribution from drawing lines, circles, polygons and arcs, it is quite accurate to simply count these operations. If a more accurate estimate is needed, the properties of the individual types of vector operations can be included.

One complication to RIP estimation is the PostScript®Xobject 123. PostScript® can have arbitrary looping structures that make estimation difficult. To overcome this problem, the invention includes fragments of PostScript® code in a PDF file and then estimates the time it takes to render each of those fragments. The invention assigns a constant RIP time to any PostScript® object. These objects are likely to be rare in PDF documents, and will be included only in the case when PDF cannot express the same drawing operations. Therefore, PostScript®Xobject 123 is likely to consume a large amount of RIP time. If the estimate does not need to be very accurate, the invention uses a constant value (determined from historical experiments) assigned to any of these PostScript®Xobjects 123. If a better estimate is needed, various heuristics are used to improve accuracy. The size of the PostScript® fragment, the number of loops, or the initial values of loop variables can help to estimate the RIP time for the object.

RIP times also depend on the computer system being used, and the load from other processes on that system. Although these variables can be readily controlled while the estimator is being initialized, there is a possibility that the estimator may be applied to RIPs on various systems. Perhaps also, the RIP is encountering a new font which has not been previously analyzed. The invention accommodates for such situations by using a feedback mechanism that accounts for such variability when the estimator is used with a RIP to process the job.

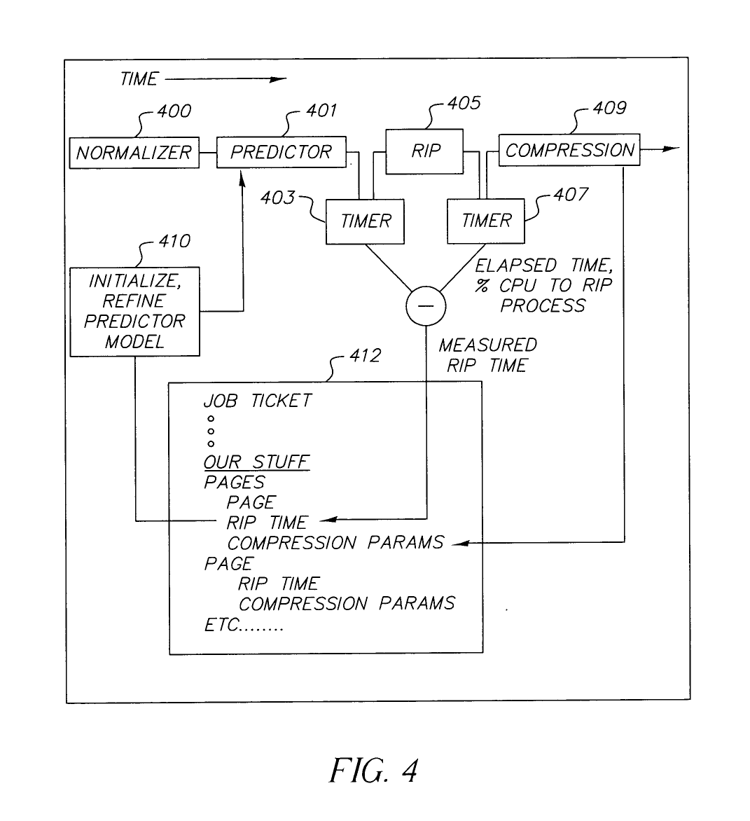

FIG. 4 shows the processing of the invention that integrates the predictor 401 (or estimator as it may also be called) with Adobe® job ticket processing. In this scenario, the system is set up to measure the RIP time. The RIP time for each page is then stored with other parameters in the job ticket 412. More specifically, FIG. 4 illustrates a normalizer 400 that inputs to the predictor 401. Timers 403, 407 for the job ticket processing (JTP) control both the JTP and the RIP 405. The compression is shown as item 409. The job ticket 412 is utilized before the initialization, and refining of the predictor model, as shown in item 410. More specifically, job ticket 412 includes the raster image processing time, compression parameters and the like, for the different pages. The predictor 401 can examine the timing results and make adjustments in its model in order to improve the estimate in future jobs. In this way, the estimator, or predictor 401, is trained when ported to different systems, or when new fonts are used.

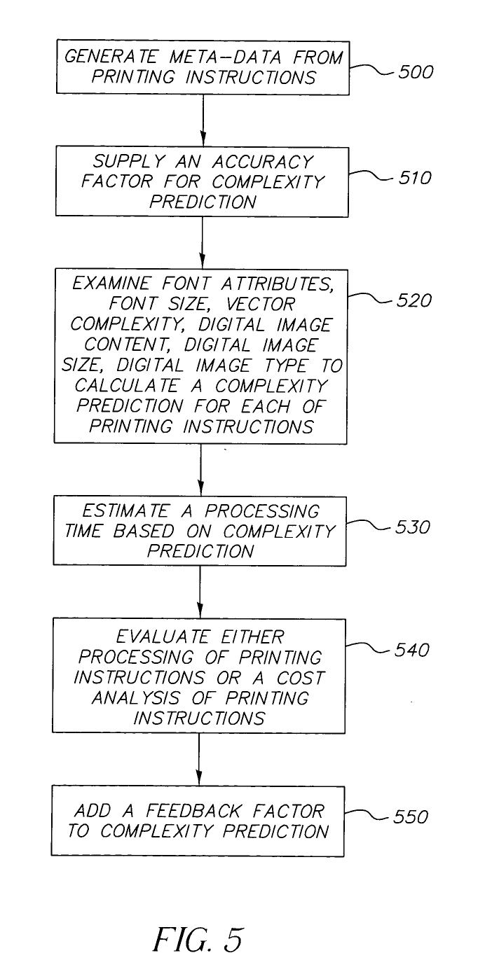

FIG. 5 shows a flowchart, which shows the processing of the invention. In item 500, the invention generates meta-data from the printing instructions. Next, in item 510, the invention supplies an AF for the complexity prediction. In item 520, the invention examines font attributes, font sizes, vector complexity, digital image content, digital image size and digital image type, to calculate a complexity prediction for each of the printing instructions. Next, item 530 of the invention estimates a processing time based on the complexity prediction. Item 540 evaluates either processing of printing instructions or a cost analysis of printing instructions. Lastly, in item 550, the invention adds a FF to the complexity prediction.

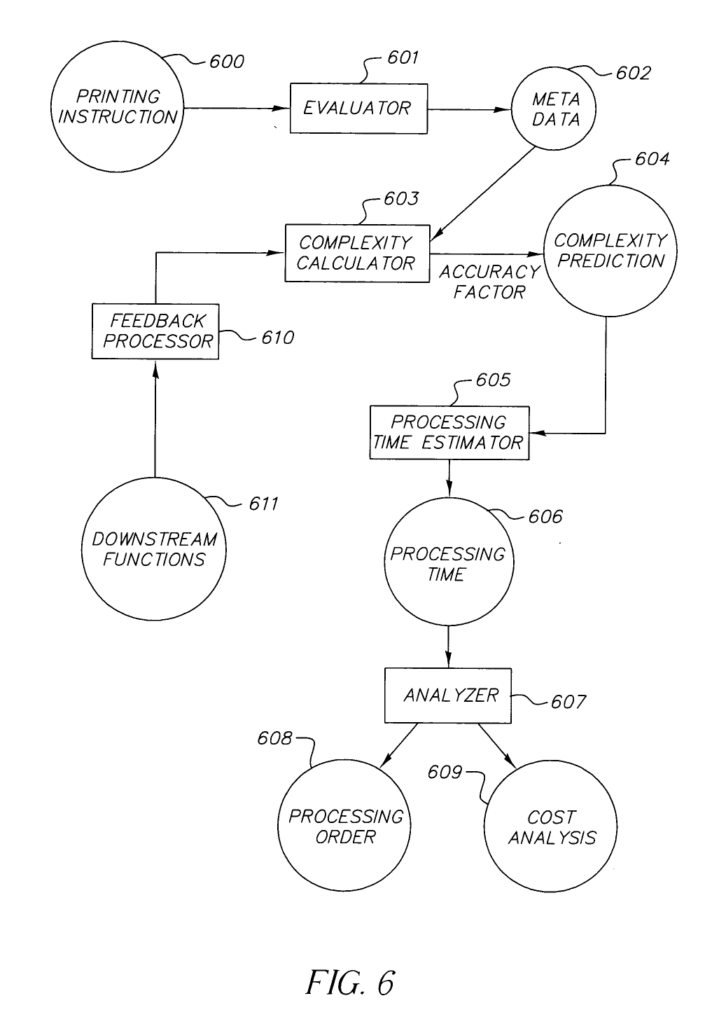

The system for performing this activity is shown in FIG. 6. More specifically, an evaluator 601 generates meta-data 602 from printing instructions 600. A feedback processor 610 takes information from downstream functions 611 and supplies the same information to a complexity calculator 603. The complexity calculator 603 performs a complexity prediction 604 (moderated by the AF) based on information received from the feedback processor 610, such as font attributes, font sizes, vector complexity, digital image content, digital image size, a digital image type, etc. From the complexity prediction 604, a processing time estimator 605 can produce an estimated processing time 606. The analyzer 607 produces a processing order 608 and a cost analysis 609 based on the processing time 606.

In addition to the scheduling features discussed above, the invention can also be used for accounting or print run cost estimation information provided from the derived meta-data. This is derived at the print generation client, at the RIP, or at any other intermediate location such as a print server or RIP services manager. This information is useful as a preflight function and as a run time estimator for demand print applications such as printing variable content (personalized) printing.

The invention is also very useful for assisting the scheduling and utilization of an intelligent RIP raster page or object spooler. In the case of a multiple or single RIP environment, with the invention, only the most complex pages or objects which cannot be rendered at the speed of the print engine need be spooled. Remaining pages or objects are rendered in real time and merged with those previously spooled on the fly.

The invention is useful with assisting in the scheduling and utilization of an intelligent RIP raster page or object spooler. In the case of a multiple or single RIP environment, the invention provides an algorithm to manage a spooling mechanism which combines a minimum/maximum leveling of content storage to make it more efficient. The algorithm uses information about the PDL complexity to manage the spooling mechanism. In addition, the invention assists in the object or page RIP scheduling and caching schemes as utilized in a single or multiple RIP environments when printing variable content (personalized) PDL jobs.

The generation of the meta-data information is accomplished via a novel approach that utilizes a software utility to study the PDL content and derive or predict content complexity. This software utility is a component in one or a combination of locations. For example, the invention can be used on the client application utilizing a software plug in or extension, or modification to the base application functionality. The generation of the meta-data could occur prior to, concurrent with, or following the print driver or PDL generation phase of the output generation.

The invention can also be used on the print server utilizing a software application which would analyze the specific content of the PDL stream and generate the meta-data information. Further, the invention is useful when placed on the DFE or RIP as a software processing component during the PDL readiness phase.

By examining specific components: font attributes, font size, vector complexity, digital image content size/resolution/type and applying idiom recognition assessment and mathematical summaries, the invention generates a CF. This CF is the content basis of the meta-data generation. The CF provides the basis of information to be utilized by downstream functions as outlined previously.

An extension to the above outlined meta-data generation concept is to add an AF to the CF. The AF is determined by a user, an application, a preflight utility, or some other similar requestor. The AF is a relative index that establishes the desired relative accuracy required by the downstream functions.

A low AF would indicate to the CF generation utility that a brief cursory check of the PDL content is adequate. In this scenario, the meta-data would only provide a rough assessment of the complexity of the PDL. This would, for example, be sufficient for a rough order of magnitude in a page ordering scheme for a multi RIP DFE. A high AF would indicate to the CF generation utility that a more accurate and extensive check of the PDL content is required. In this scenario, the meta-data would provide sufficient assessment of the complexity of the PDL for more substantial downstream tasks. This would, for example, be sufficient to determine the possibility of real time rendering within a DFE to maintain rendering speed for the print engine it is driving. A specific example for a CF would be a value of 1-10 and an AF would also have a value of 1-10. If the AF is 10, then the CF is an exact value. If the AF is 1, then the CF could be in error by as much as plus/minus 2 (i.e., if the reading is 8, actual may be 6, 7, 8, 9, or 10). If the AF is 5, then the CF could be in error by as much as plus/minus 1 (if the reading is 8, actual may be 7, 8, or 9).

An additional extension to the above outlined meta-data generation concept is to add a FF to the CF. The FF is generated by the downstream function and provides information on the exact complexity of the PDL content (for example post RIP rendering). This FF, relayed back to the CF utility, could provide information to the CF to adjust its prediction capability for a specific application. This scenario would result in a specific closed loop complexity prediction machine.

An alternate extension to the above outlined FF concept is for specific downstream tasks, such as a DFE, to have predetermined FF values based on a specific set of criteria or a set of test cases. These predetermined FF values are published with products when they are furnished to their customers, stored on a web site for reference and access, or provided via other standard communication methods. This predetermined FF is utilized by the CF generation function in the same way the in line closed loop FF is utilized (to provide a more accurate assessment for a specific application).

Some benefits of the invention are faster end-to-end time to produce a job in a print processing system. Another benefit is faster end-to-end time to soft proof or view a job in a display, or soft proof a preflight application. Another benefit is less hardware resources are potentially required which will reduce the costs for an equivalent performance (less memory, less RIP hardware, less storage). Another benefit is a simpler and more accurate determination of the configuration of a scaleable RIP or rendering architecture. Another benefit is a more appropriate fit for a specific RIP or software system to a specific user's environment.

The invention can be used in the following environments: within a RIP, within a viewer, within a preflight application, within a soft proof application, within a sales/configuration tool, within a DFE page processing or ordering system, within a page ordering or storage subsystem, or within an upstream workflow application which adds meta-data information to an existing data stream to provide hints to downstream applications (RIP's, viewers, etc).

The foregoing description has detailed the embodiments most preferred by the inventors. Variations of these embodiments will be readily apparent to those skilled in the art and, accordingly, the scope of the invention should be measured by the appended claims.

### Parts List

| Item | Description |
|---|---|
| 100 | PDFOp (operations) |
| 101 | MarkingContext |
| 105 | NumberStack |
| 106 | BoolStack |
| 107 | NameStack |
| 108 | GraphicsStack |
| 109 | currentGraphicsState |
| 110 | Resources |
| 115 | FontList |
| 116 | XObjList |
| 120 | FontObject |
| 121 | imageXobject |
| 122 | FormXobject |
| 123 | PostScript ®Xobject |
| 130 | ParseStream |
| 131 | AllMarkingOperators |
| 300 | PDFobject |
| 302 | PDFOp |
| 305 | rootOp |
| 306 | Marking Context |
| 307 | Resouces |
| 310 | formOp |
| 311 | Marking Context |
| 312 | Resources |
| 400 | Normalizer |
| 401 | Predictor |
| 403 | Timer |
| 405 | RIP |
| 407 | Timer |
| 409 | Compression |
| 410 | Initialize, refine predictor model |
| 412 | Job Ticket |

What is claimed is:

1. A method of controlling printing devices, said method comprising:
generating meta-data from printing instructions;
calculating a complexity prediction for each of said printing instructions;
estimating a processing time for each of said printing instructions based on said complexity prediction; and
evaluating said printing instructions based on said processing time.

2. The method in claim 1, wherein said evaluating produces one or more of:
an order of processing said printing instructions; and
a cost analysis of said printing instructions.

3. The method in claim 2, wherein said processing of said printing instructions includes one or more of raster image processing and spooling.

4. The method in claim 1, wherein said generating of said meta-data comprises examining one or more of font attributes, font size, vector complexity, digital image content, digital image size, and digital image type.

5. The method in claim 1; further comprising supplying an accuracy factor for said complexity prediction.

6. The method in claim 5, wherein said accuracy factor controls a processing precision of said complexity prediction calculation.

7. The method in claim 1, further comprising adding a feedback factor to said complexity prediction based on responses from downstream functions.

8. A method of controlling printing devices, said method comprising:
generating meta-data from printing instructions;
examining one or more of font attributes, font size, vector complexity, digital image content, digital image size, digital image type to calculate a complexity prediction for each of said printing instructions;
estimating a processing time for each of said printing instructions based on said complexity prediction; and
evaluating said printing instructions based on said processing time.

9. The method in claim 8, wherein said evaluating produces one or more of:
an order of processing said printing instructions; and
a cost analysis of said printing instructions.

10. The method in claim 9, wherein said processing of said printing instructions includes one or more of raster image processing and spooling.

11. The method in claim 10, further comprising supplying an accuracy factor for said complexity prediction.

12. The method in claim 11, wherein said accuracy factor controls a processing precision of said complexity prediction calculation.

13. The method in claim 8, further comprising adding a feedback factor to said complexity prediction based on responses from downstream functions.

14. A program storage device readable by machine, tangibly embodying a program of instructions executable by the machine to perform a method of controlling printing devices, said method comprising:
generating meta-data from printing instructions;
calculating a complexity prediction for each of said printing instructions;
estimating a processing time for each of said printing instructions based on said complexity prediction; and
evaluating said printing instructions based on said processing time.

15. The program storage device in claim 14, wherein said evaluating produces one or more of:
an order of processing said printing instructions; and
a cost analysis of said printing instructions.

16. The program storage device in claim 15, wherein said processing of said printing instructions includes one or more of raster image processing and spooling.

17. The program storage device in claim 14, wherein said generating of said meta-data comprises examining one or more of font attributes, font size, vector complexity, digital image content, digital image size, and digital image type.

18. The program storage device in claim 14, further comprising supplying an accuracy factor for said complexity prediction.

19. The program storage device in claim 18, wherein said accuracy factor controls a processing precision of said complexity prediction calculation.

20. The program storage device in claim 14, further comprising adding a feedback factor to said complexity prediction based on responses from downstream functions.
